(19) United States
(12) Patent Application Publication
(10) Pub. No.: US 2014/0146135 A1
(43) Pub. Date: May 29, 2014

(54) IMAGE PROCESSING APPARATUS AND IMAGE PROCESSING METHOD

(71) Applicant: Kabushiki Kaisha Toshiba, Tokyo (JP)

(72) Inventor: Yoshiyasu Itoh, Tokyo (JP)

(73) Assignee: KABUSHIKI KAISHA TOSHIBA, Tokyo (JP)

(21) Appl. No.: 13/963,192

(22) Filed: Aug. 9, 2013

(30) Foreign Application Priority Data
Nov. 28, 2012 (JP) 2012-260172

(51) Int. Cl. H04N 5/272

(52) U.S. Cl. CPC H04N 5/272
USPC 348/43; 348/569

(57) ABSTRACT

According to one embodiment, an image processing apparatus includes an image generating module, and an image synthesizer. The image generating module is configured to generate a turning-over image that is an image on a turning-over section obtained by folding a part of an area of a main image input. The main image is transmitted through the turning-over section. The image synthesizer is configured to arrange a sub image on a part of the area of the main image, and synthesize the main image, the turning-over image, and the sub image.

This application is based upon and claims the benefit of priority from Japanese Patent Application No. 2012-260172, filed Nov. 28, 2012, the entire contents of which are incorporated herein by reference.

### FIELD

Embodiments described herein relate generally to an image processing apparatus and an image processing method.

### BACKGROUND

Conventionally, there is known a technique for superposing a main image and a sub image on a screen to display them at the same time.

There are some kinds of images that are prohibited or not preferred to be displayed directly with main images in a superimposed manner. In the conventional technique, even such images are displayed as sub images with main images in a superimposed manner.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a configuration of a digital television set according to a first embodiment;

FIG. 2 is an exemplary block diagram of a functional configuration of a video processor in the first embodiment;

FIG. 3 is an exemplary diagram of an example of a synthesized image generated and displayed in the first embodiment;

FIG. 4 is an exemplary flowchart of procedures of video processing in the first embodiment;

FIG. 5 is an exemplary flowchart of procedures of sub image generation processing according to a second embodiment;

FIGS. 6A, 6B, 6C, and 6D are exemplary diagrams of examples in which different kinds of sub images A to D are displayed, respectively, depending on a turning-over position in the second embodiment;

FIG. 7 is an exemplary block diagram of a functional configuration of a video processor according to a third embodiment;

FIG. 8 is an exemplary block diagram of a functional configuration of an audio processor in the third embodiment;

FIG. 9 is an exemplary flowchart of procedures of video processing in the third embodiment;

FIG. 10 is an exemplary flowchart of procedures of audio processing in the third embodiment;

FIGS. 11A and 11B are exemplary diagrams for explaining the relationship between a turning-over amount and a channel shift in the third embodiment;

FIG. 12 is an exemplary flowchart of procedures of audio processing according to a fourth embodiment;

FIG. 13 is an exemplary diagram of a screen display example according to a first modification;

FIGS. 14A and 14B are exemplary diagrams of screen display examples according to a second modification;

FIG. 15 is an exemplary diagram of a display example according to a fifth modification; and

FIG. 16 is an exemplary diagram of a display example according to a sixth modification.

### DETAILED DESCRIPTION

In general, according to one embodiment, an image processing apparatus includes an image generating module, and an image synthesizer. The image generating module is configured to generate a turning-over image that is an image on a turning-over section obtained by folding a part of an area of a main image input. The main image is transmitted through the turning-over section. The image synthesizer is configured to arrange a sub image on a part of the area of the main image, and synthesize the main image, the turning-over image, and the sub image.

In the following, an image processing apparatus and an image processing method of embodiments are described in detail with reference to the enclosed drawings. In the following embodiments, a digital television set having therein a tuner for receiving digital broadcasting is exemplified as the image processing apparatus. However, in the embodiments, an image processing apparatus is not limited to a digital television set, and may be devices such as a hard disk recorder and a set-top box that have a tuner receiving broadcast waves and process images to output them to an externally-connected display device, or may be a monitor that does not have a tuner and receives video and audio input from an external tuner.

### First Embodiment

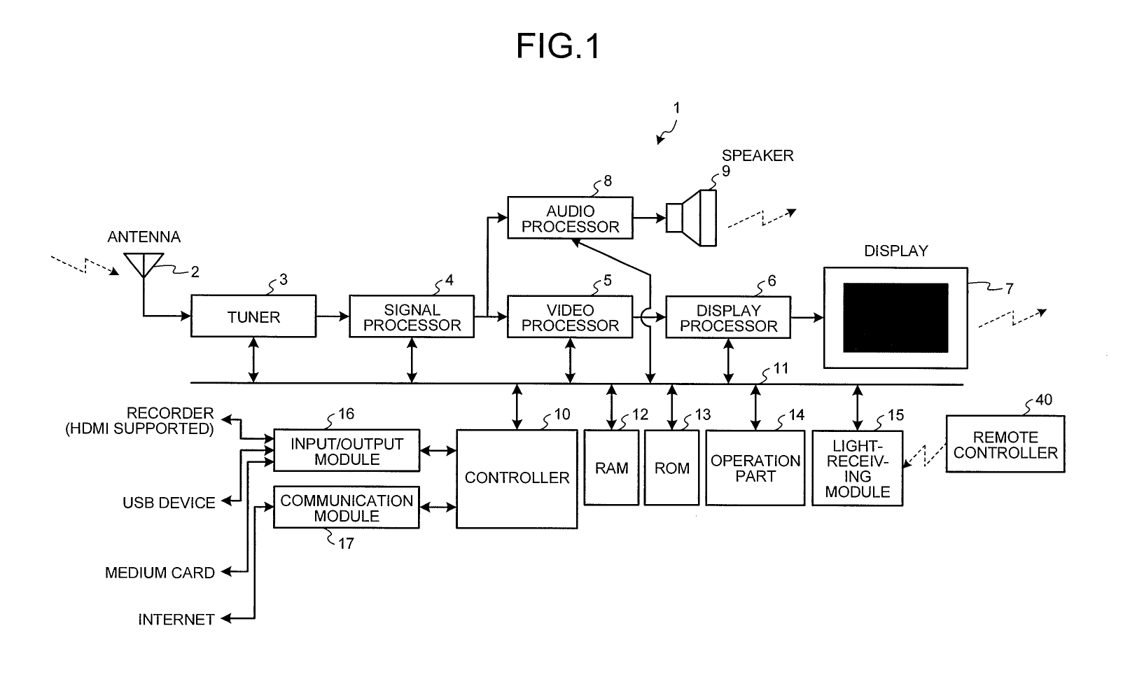

As illustrated in FIG. 1, a digital television set 1 in the first embodiment mainly comprises an antenna 2, a tuner 3 for receiving digital broadcasting, a signal processor 4, a video processor 5, a display processor 6, a display 7, an audio processor 8, a speaker 9, a controller 10, a communication line 11, a random access memory (RAM) 12, a read only memory (ROM) 13, an operation part 14, a light-receiving module 15, an input/output module 16, and a communication module 17.

The antenna 2 receives digital broadcasting of a broadcasting satellite (BS), a communication satellite (CS), ground waves, etc. The tuner 3 selects a channel to be viewed that is instructed by a user. The signal processor 4 extracts signals demodulated by the tuner 3 and signals input from the input/output module 16 as various digital signals to process them, under control of the controller 10. The signal processor 4 separates input signals to video signals and audio signals, and outputs video signals to the video processor 5 and audio signals to the audio processor 8.

The video processor 5 processes video signals input from the signal processor 4 to generate and synthesize a main image, a sub image, a turning-over image, etc., which are described later, and performs three-dimensional processing on such images, for example. In the first embodiment, the video signals input from the signal processor 4 are video signals for the main image. The details of such processing are described later.

The video processor 5 performs processing for adjusting the video signals input from the signal processor 4 to an adequate screen size, and processing for removing noise included in video signals as image quality processing for improving the image quality of video, for example.

The display processor 6 performs processing for displaying, on the display 7, video signals obtained by synthesizing the main image, the sub image, and the turning-over image that are output from the video processor 5. The display processor 6 further superimposes on-screen display (OSD) such as character information on the video signals output from the video processor 5. The display 7 displays video signals on a screen. Then, the user views television video by viewing the screen of the display 7.

The audio processor 8 performs acoustic treatment on audio signals and amplifies them. The speaker 9 outputs audio signals as audio. Then, the user listens to television audio by listening to audio from the speaker 9.

The controller 10 controls each module of the digital television set 1. The controller 10 is a processing unit capable of sequence processing, and sequentially executes programs stored in the ROM 13 while loading them onto the RAM 12, thus outputting control signals to each module of the digital television set 1 so as to perform central control of the operation of the digital television set 1.

The communication line 11 connects between the tuner 3, the signal processor 4, the video processor 5, the display processor 6 and the audio processor 8, and the controller 10, and data is received and transmitted between the controller 10, and the tuner 3, the signal processor 4, the video processor 5, the display processor 6 and the audio processor 8. The communication line 11 may be an IIC-BUS, etc. concretely. The RAM 12 and the ROM 13 store various kinds of data, and such data is received from and transmitted to the controller 10.

The operation part 14 is a switch receiving operation instructions from the user. The light-receiving module 15 receives signals transmitted by a remote controller 40 having received an operation instruction from the user. The user can operate the digital television set 1 and each device connected to the digital television set 1 by operating various buttons on the remote controller 40.

In the first embodiment, the user inputs a main image turning-over instruction, a turning-over position and a turning-over amount on the main image, etc. through the operation part 14 or the remote controller 40, and the controller 10 receives such input instructions. The operation part 14 and the remote controller 40, the light-receiving module 15, and the controller 10 function as an input receiving module.

The communication module 17 has a function of communicating with a server connected through a network such as the Internet. The communication module 17 requests information from the server, and receives information transmitted from the server.

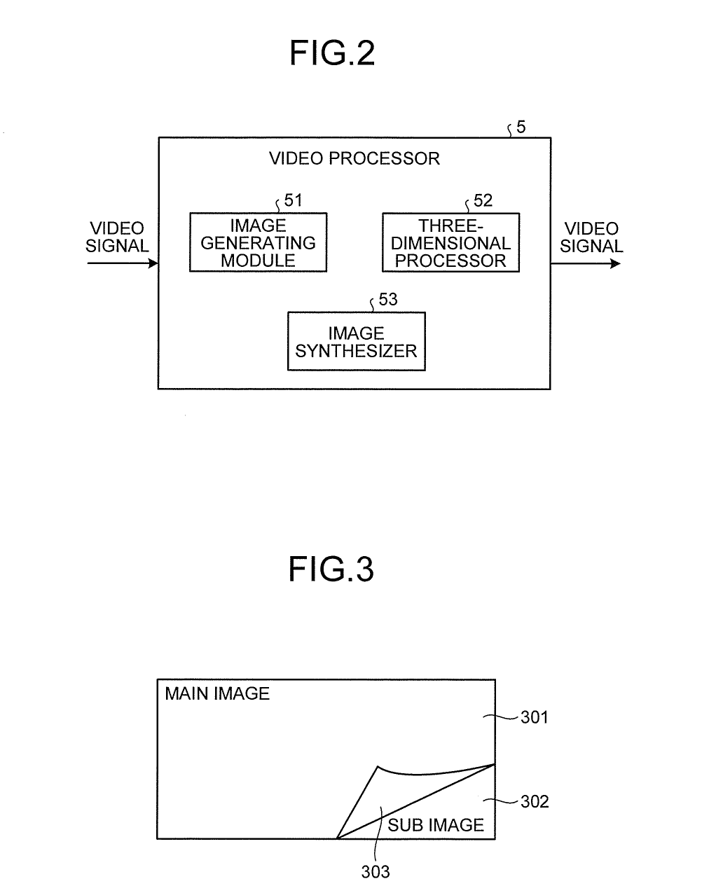

Next, the details of the video processor 5 are described with reference to FIG. 2. For the convenience of description, FIG. 2 illustrates processors having functions of generating the main image, the sub image, the turning-over image, etc., of synthesizing them and of performing three-dimensional processing on such images, among all functions of the video processor 5, and omits processors related to the rest of functions of the video processor 5.

The video processor 5 mainly comprises an image generating module 51, an image synthesizer 53, and a three-dimensional processor 52, as illustrated in FIG. 2.

The image generating module 51 generates a turning-over image based on video signals input to the video processor 5 from the signal processor 4, that is, based on the main image. The turning-over image is a semitransparent image of a turning-over section obtained by folding a corner as a part of the area of the main image. The main image is transmitted through the turning-over image. In the first embodiment, the image generating module 51 generates a turning-over image when the controller 10 receives inputs of the turning-over instruction, the turning-over position specifying a corner, and the turning-over amount from the user through the operation part 14 or the remote controller 40.

That is, when a turning-over instruction is input, the image generating module 51 folds the specified corner of the main image as a turning-over position with the specified turning-over amount, which are indicated at the same time when the turning-over instruction is input, to generate a turning-over image on a turning-over section resulted by folding operation and arranged to be semitransparent. In other words, the turning-over image is an image obtained by turning back the main image displayed before the turning-over instruction is input. Here, a known method is used to generate the turning-over image.

The three-dimensional processor 52 performs three-dimensional processing for converting the turning-over image to a stereoscopic image. Here, a known method is used for three-dimensional processing. The three-dimensional processor 52 may be configured so as to perform three-dimensional processing on the main image or the sub image to display it stereoscopically.

The image synthesizer 53 arranges a sub image on an area where the main image is turned over, that is, in a corner as a part of the area of the main image, and synthesizes the main image, the turning-over image generated by the image generating module 51 and subjected to three-dimensional processing by the three-dimensional processor 52, and the sub image. The image synthesizer 53 synthesizes them so that the turning-over image overlaps on the main image. As a result, the corner of the stereoscopic main image is turned over stereoscopically, whereby a stereoscopic turning-over image on the turning-over section transmitting the main image therethrough, and the sub image are obtained. Viewing the display of the synthesized image thereof, the user visually recognizes an image in which the main image seems to be positioned behind the semitransparent turning-over image.

Here, the sub image may be arbitrary video. The image generating module 51 can generate the sub image based on the main image. For example, the image generating module 51 generates the sub image based on metadata of the main image, etc. Alternatively, the image generating module 51 may acquire, as the sub image, video signals of a channel other than the channel of the main image. It is also possible to configure so that the user specifies the sub image through the operation part 14 or the remote controller 40.

As illustrated in FIG. 3, in the synthesized image, a turning-over image 303 is generated by folding the lower right corner of a main image 301, and a sub image 302 is displayed in the area where the main image 301 is turned over. Although the synthesized image is illustrated as a flat image in the example of FIG. 3, it is actually displayed stereoscopically by the three-dimensional processor 52. The form of the stereoscopic display may be such that the main image 301 is displayed as a two-dimensional image without a parallax and the turning-over image 303 is stereoscopically displayed with a stereoscopic effect like a tuned-over sheet, for example. Alternatively, the main image 301 may be displayed stereoscopically.

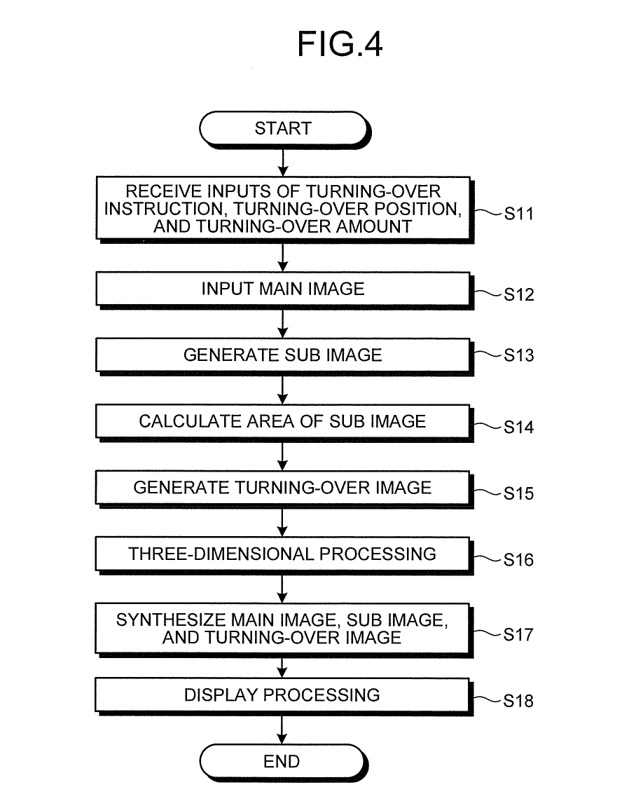

Next, the video processing in the first embodiment, which is configured as described above, is described with reference to FIG. 4. First, the controller 10 receives inputs of the turning-over instruction, the turning-over position, and the turning-over amount through the operation part 14 or the remote controller 40 (S11).

The signal processor 4 inputs video signals of the main image to the video processor 5 (S12). The image generating module 51 generates the sub image as described above (S13). Next, the image generating module 51 calculates an area of the sub image based on the input turning-over amount (S14). Then, the image generating module 51 generates a turning-over image by turning over the specified corner of the main image as a turning-over position with the specified turning-over amount (that is, a size corresponding to the area of the sub image) (S15).

The three-dimensional processor 52 performs three-dimensional processing for converting the turning-over image generated at S15 to a stereoscopic image (S16). Here, when the three-dimensional processing is performed on the turning-over image, a parallax is calculated based on a protrusion amount of the turning-over image in accordance with the turning-over amount. The main image or the sub image may be converted to a stereoscopic image at S16, as described above. Next, the image synthesizer 53 synthesizes the main image, the turning-over image, and the sub image (S17) that have been processed in the earlier steps, to generate a synthesized image. The synthesized image is output to the display processor 6 from the video processor 5. The display processor 6 performs display processing for displaying the synthesized image on the display 7 (S18).

In the first embodiment, a corner area of the main image is folded so as to generate a turning-over image on a turning-over section resulted by folding operation and arranged to be semitransparent, as described above. Then, the sub image is arranged on the area where the main image is turned over (corner area of the main image), and the main image, the turning-over image, and the sub image are synthesized to be displayed on the display 7.

### Second Embodiment

The sub image is arbitrary video in the first embodiment, while the kind of the sub image arranged at a corner of the main image is changed depending on a turning-over position in the second embodiment.

The configuration of the digital television set 1 and the functional configuration of the video processor 5 in the second embodiment are the same as in the first embodiment. In the second embodiment, the image generating module 51 generates a different sub image depending on a turning-over position input by the user and received by the controller 10.

Here, different kinds of sub images include images related to the information of characters in a program of the main image, advertising images of products related to products treated in the program of the main image, and images of recommended contents related to the main image, for example. However, the sub images are not limited thereto. It is possible to define arbitrarily what kind of sub image is arranged at which turning-over position.

When such different kinds of sub images are displayed in the digital television set 1, the communication module 17 transmits a request for information related to the main image to an external server, for example, so that the sub image is displayed based on the information transmitted in response to the request.

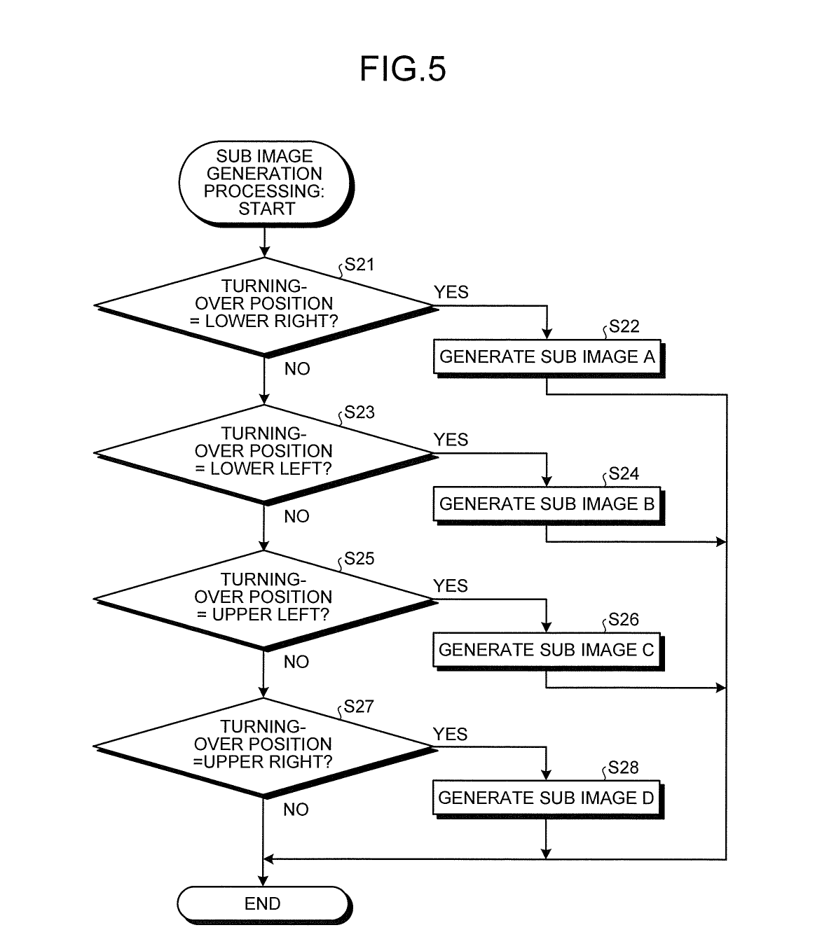

The entire flow of video processing in the second embodiment is the same as in the first embodiment described with reference to FIG. 4. In the video processing, the second embodiment is different from the first embodiment in the processing for generating a sub image at S13. The processing for generating a sub image in the second embodiment is described with reference to FIG. 5. In the following description, a sub image A, a sub image B, a sub image C, and a sub image D are different in kind to one another.

First, the image generating module 51 determines whether the input turning-over position is at the lower right portion of the main image (S21). If the input turning-over position is at the lower right portion of the main image (Yes at S21), the image generating module 51 generates the sub image A (S22). Then, the image generating module 51 finishes the processing for generating a sub image.

If the input turning-over position is not at the lower right portion of the main image at S21 (No at S21), the image generating module 51 determines whether the input turning-over position is at the lower left portion of the main image (S23). If the input turning-over position is at the lower left portion of the main image (Yes at S23), the image generating module 51 generates the sub image B (S24). Then, the image generating module 51 finishes the processing for generating a sub image.

If the input turning-over position is not at the lower left portion of the main image at S23 (No at S23), the image generating module 51 determines whether the input turning-over position is at the upper left portion of the main image (S25). If the input turning-over position is at the upper left portion of the main image (Yes at S25), the image generating module 51 generates the sub image C (S26). Then, the image generating module 51 finishes the processing for generating a sub image.

If the input turning-over position is not at the upper left portion of the main image at S25 (No at S25), the image generating module 51 determines whether the input turning-over position is at the upper right portion of the main image (S27). If the input turning-over position is at the upper right portion of the main image (Yes at S27), the image generating module 51 generates the sub image D (S28).

If the input turning-over position is not at the upper right portion of the main image at S27 (No at S27), the image generating module 51 finishes the processing for generating a sub image.

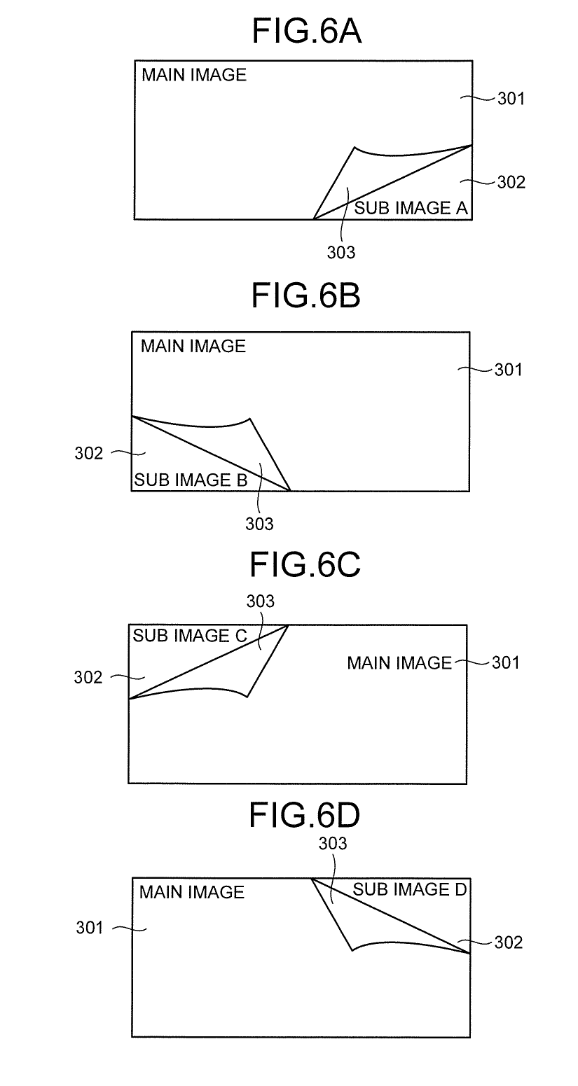

Through the above processing, the different kinds of sub images A to D, depending on a turning-over position, are displayed, as illustrated in FIG. 6. In this manner, it is possible to display a different kind of sub image and a main image depending on a turning-over position at the same time.

### Third Embodiment

The sub image is arbitrary video in the first embodiment, while video of a channel different from the channel of the main image is used as the sub image in the third embodiment, and the channel shift is performed based on turning-over operation.

The configuration of the digital television set 1 in the third embodiment is the same as in the first embodiment. The third embodiment is different from the first embodiment in the configurations of a video processor 605 and an audio processor 608.

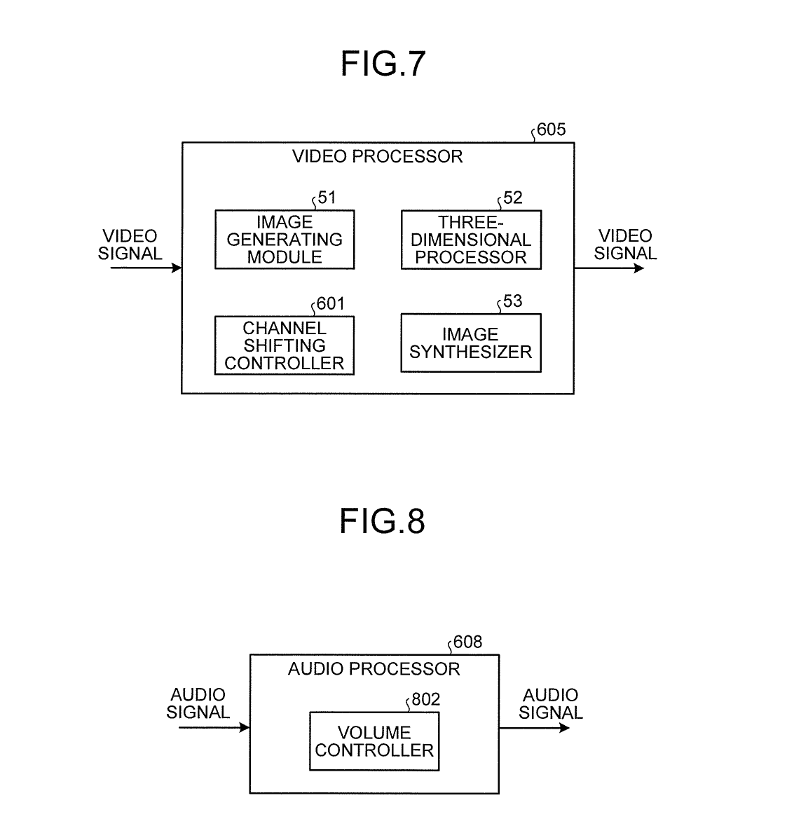

The video processor 605 of the third embodiment mainly comprises the image generating module 51, the image synthesizer 53, the three-dimensional processor 52, and a channel shifting controller 601, as illustrated in FIG. 7. Here, the functions of the image generating module 51, the image synthesizer 53, and the three-dimensional processor 52 are the same as in the first embodiment.

The channel shifting controller 601 shifts a channel to be controlled by operation. To be more specific, the channel shifting controller 601 shifts the channel to be controlled by operation to the channel of the sub image (sub channel) when the turning-over amount is equal to or larger than a predetermined threshold. Here, the control by operation is control in accordance with an operation input from an operation input device such as the remote controller, and is control in accordance with operation input such as “change volume”, “change channel”, “record”, “display program information”, and “register as favorite”, for example. Receiving such operation inputs, the digital television set 1 controls the channel to be controlled by operation. In the third embodiment, the predetermined threshold is set to be an amount corresponding to a half of the area of the main image.

The audio processor 608 of the third embodiment mainly comprises a volume controller 802, as illustrated in FIG. 8. The volume controller 802 controls the audio volume of the channel of the main image and the audio volume of the channel of the sub image. In the third embodiment, the volume controller 802 increases the audio volume of the channel of the sub image as the turning-over amount is increased.

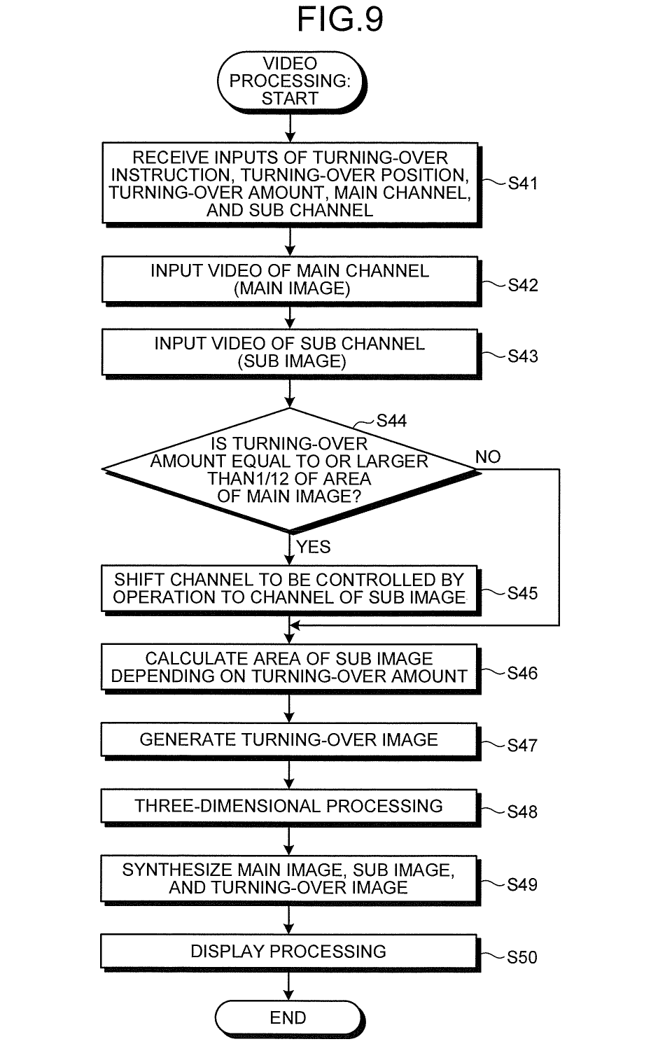

Subsequently, the video processing in the third embodiment, which is configured as mentioned above, is described with reference to FIG. 9. First, the controller 10 receives inputs of the turning-over instruction, the turning-over position, the turning-over amount, a channel displayed as the main image (main channel), and a channel displayed as the sub image (sub channel) through the operation part 14 or the remote controller 40 (S41).

Next, the signal processor 4 inputs the video signals of the main channel (main image) to the video processor 605 (S42), and inputs the video signals of the sub channel (sub image) to the video processor 605 (S43).

Then, the channel shifting controller 601 determines whether the input turning-over amount is equal to or larger than a half of the area of the main image, which is the predetermined threshold (S44). If the input turning-over amount is equal to or larger than a half of the area of the main image (Yes at S44), the channel shifting controller 601 shifts the channel to be controlled by operation to the channel of the sub image (sub channel) (S45).

If the input turning-over amount is smaller than a half of the area of the main image (No at S44), the channel to be controlled by operation is not shifted at S45.

Next, the image generating module 51 calculates the size of the area of the sub image in accordance with the turning-over amount (S46). In the subsequent steps, the image generating module 51 generates a turning-over image by turning over the specified corner of the main image as a turning-over position with the specified amount, similarly to the first embodiment (S47).

Then, the three-dimensional processor 52 performs three-dimensional processing for converting the turning-over image generated at S47 to a stereoscopic image, similarly to the first embodiment (S48). Next, the image synthesizer 53 synthesizes the main image, the turning-over image, and the sub image (S49) that have been processed in the earlier steps, to generate a synthesized image. The synthesized image is output to the display processor 6 from the video processor 605. The display processor 6 performs display processing for displaying the synthesized image on the display 7 (S50).

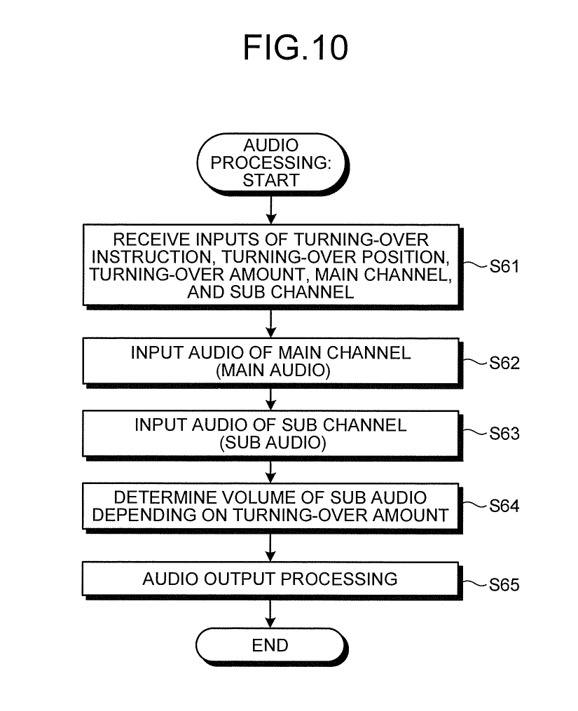

Subsequently, the audio processing in the third embodiment is described with reference to FIG. 10. When the controller 10 receives inputs of the turning-over instruction, the turning-over position, the turning-over amount, the main channel, and the sub channel through the operation part 14 or the remote controller 40 (S61), the signal processor 4 inputs audio signals of the main channel (main audio) to the audio processor 608 (S62), and inputs audio signals of the sub channel (sub audio) to the audio processor 608 (S63).

Next, the volume controller 802 determines the volume of the sub audio depending on the turning-over amount (S64). To be more specific, the volume controller 802 determines the volume of the sub audio so that it is increased as the turning-over amount is increased. Then, the audio processor 608 performs processing for outputting the main audio and sub audio to the speaker 9 with the respectively-determined volume (S65).

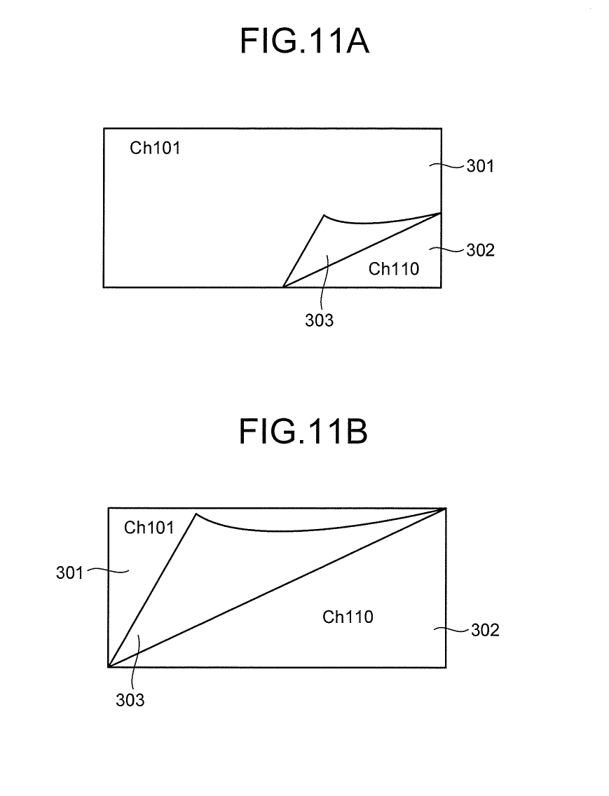

When the turning-over amount is smaller than the threshold, as illustrated in FIG. 11A, the video of a channel Ch101 is displayed as the main image 301, and the video of the channel Ch110 is displayed as the sub image 302 in the area where the main image 301 is turned over. Here, the channel to be controlled by operation is the channel Ch101 displayed as the main image 301. The volume of the sub audio is increased as the turning-over amount is increased.

When the turning-over amount is equal to or larger than a half of the area of the main image, which is the threshold, as illustrated in FIG. 11B, the channel to be controlled by operation is shifted to the channel Ch110 of the sub image 302. The audio processor 608 may be configured not to output the audio of the channel Ch101 that is no longer the channel to be controlled by operation after shifting.

In the third embodiment, video of a channel different from the channel of the main image is used as the sub image. Thus, it is possible to display the sub image and the main image at the same time. Moreover, in the third embodiment, the volume of the sub channel is increased as the turning-over amount is increased, and the channel to be controlled by operation is shifted to the channel of the sub image once the turning-over amount becomes equal to or larger than the predetermined threshold. Thus, it is possible to easily shift channels and thus improve the convenience for the user.

### Fourth Embodiment

The volume of the sub channel is increased as the turning-over amount is increased in the third embodiment, while the audio of the channel of the sub image substitutes the audio of the channel of the main image to be output once the turning-over amount becomes equal to or larger than a predetermined threshold and the channel is shifted in the fourth embodiment.

The configuration of the digital television set 1 in the fourth embodiment is the same as in the third embodiment. The functional configurations of the video processor 605 and the audio processor 608 in the fourth embodiment are the same as in the third embodiment.

The volume controller 802 of the audio processor 608 in the fourth embodiment controls the audio volume of the main image and the audio volume of the sub image. The volume controller 802 of the fourth embodiment does not increase the audio volume of the channel of the sub image as long as the turning-over amount is smaller than the predetermined threshold, even if the turning-over amount is increased. Once the turning-over amount becomes equal to or larger than the predetermined threshold and the channel to be controlled by operation is shifted to the channel of the sub image, the volume controller 802 substitutes the audio of the channel of the main image by the audio of the channel of the sub image, which is then controlled by operation, to be output.

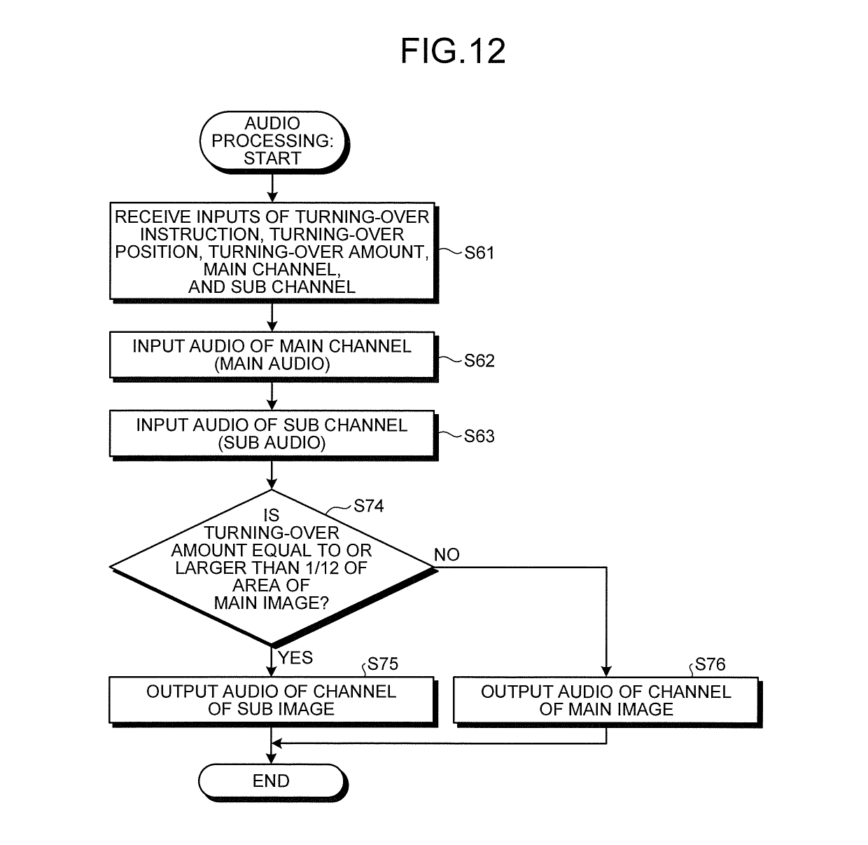

The procedures of the video processing in the fourth embodiment are the same as in the third embodiment. Next, the audio processing in the fourth embodiment is described with reference to FIG. 12.

The processing for receiving inputs of the turning-over instruction, the turning-over position, the turning-over amount, the main channel, and the sub channel, and the following steps until processing for inputting the audio of the sub channel (S61 to S63) are performed in the same manner as in the third embodiment.

Subsequently, the volume controller 802 of the audio processor 608 determines whether the turning-over amount is equal to or larger than a half of the area of the main image, which is the predetermined threshold (S74). If the turning-over amount is smaller than a half of the area of the main image (No at S74), the volume controller 802 outputs the audio of the channel of the main image (S76), and does not output the audio of the channel of the sub image.

By contrast, if the turning-over amount is equal to or larger than a half of the area of the main image at S74 (Yes at S74), the volume controller 802 outputs the audio of the channel of the sub image (S75), and does not output the audio of the channel of the main image.

Thus, when the turning-over amount is smaller than the threshold, as illustrated in FIG. 11A, the audio of the channel of the sub image 302 is not output regardless of the turning-over amount, and the audio of the channel of the main image 301 is output. By contrast, once the turning-over amount is increased and becomes equal to or larger than the threshold, as illustrated in FIG. 11B, the channel to be controlled by operation is shifted to the channel of the sub image, so that the audio of the channel of the sub image 302 is output, and the audio of the channel of the main image 301 is not output.

In the fourth embodiment, once the turning-over amount becomes equal to or larger than the predetermined threshold and the channel to be controlled by operation is shifted to the channel of the sub image, the audio of the sub image substitutes the audio of the main image to be output. This makes it possible to avoid the mixture of the audio of the channel of the main image and the audio of the channel of the sub image, and thus provide the user with more preferable viewing environments.

The above-described processing is desirable for avoiding the mixture of the audio of the channel of the main image and the audio of the channel of the sub image. However, the volume controller 802 may output the audio of the channel of the sub image and the audio of of the channel of the main image at S75. Here, the volume controller 802 performs control for changing the volume of the channel of the sub image and the volume of the channel of the main image depending on a turning-over amount. To be more specific, the volume controller 802 performs control such that the volume of the channel of the sub image is increased and the volume of the channel of the main image is decreased as the turning-over amount is increased. Once the turning-over amount becomes equal to or larger than a certain area, the volume controller 802 stops outputting the audio of the channel of the main image, which has been output until then.

In the third and fourth embodiments, the amount corresponding to a half of the area of the main image is used as the predetermined threshold. However, the threshold is not limited thereto, and an arbitrary value can be used as the predetermined threshold for channel shift.

Various modifications can be made regarding the first to the fourth embodiments. In the following, such modifications are described.

First Modification

It is possible to configure the image generating module 51 so as to determine whether contents related to the main image exist based on metadata of the main image, etc., and generate the turning-over image without receiving any instruction from the user if some related contents exist.

It is also possible to configure the image generating module 51 so as to determine whether contents related to the main image exist based on metadata of the main image, etc., and generate an image obtained by vibrating a corner as a part of the area of the main image if some related contents exist.

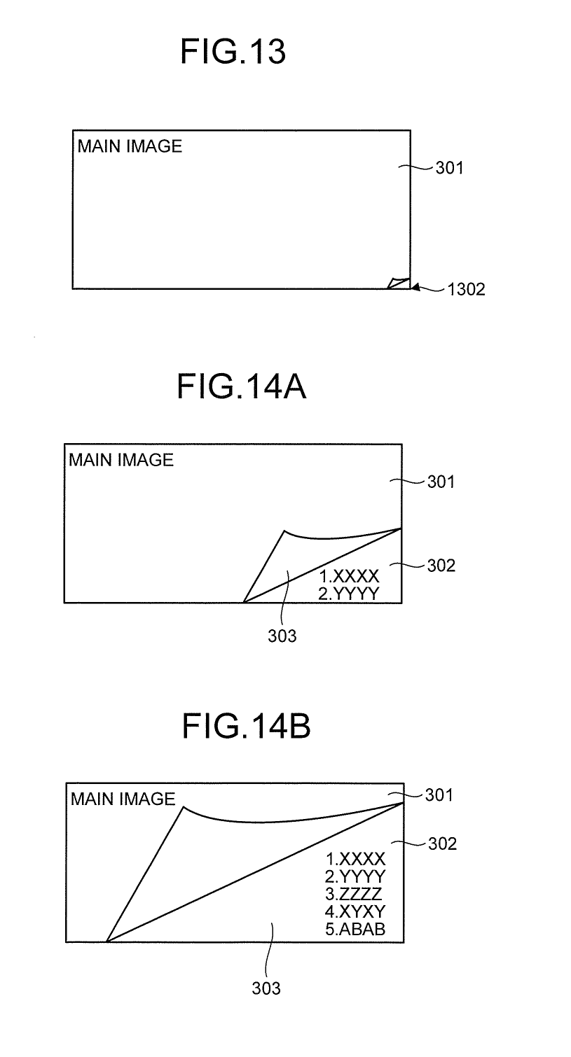

In the first modification, a corner 1302 of the main image is vibrated for display, as illustrated in FIG. 13. Thus, viewing the vibration of the corner 1302, the user can recognize that the sub image relative to the main image exists, and display the sub image through an instruction for turning over the corner 1302.

Second Modification

It is also possible to configure the image generating module 51 so as to generate the turning-over image with the turning amount of the size corresponding to the amount of information to be displayed as the sub image, e.g., the number of items, without receiving any specified turning-over amount from the user.

FIG. 14A illustrates a display example in which the number of items displayed as sub images is two, and FIG. 14B illustrates a display example in which the number of items displayed as sub images is five. As illustrated in FIGS. 14A and 14B, the turning-over amount is increased as the number of items is increased.

Third Modification

It is also possible to configure the image generating module 51 so as to perform image processing on the sub image for drawing attention of the user to the sub image.

For example, the image generating module 51 can increase the brightness of the sub image relative to that of the main image, as image processing for drawing attention of the user to the sub image. The image generating module 51 can improve the image quality of the sub image relative to that of the main image, as image processing for drawing attention to the sub image. Moreover, the image generating module 51 can set a display mode of the sub image to be brighter than that of the main image, as image processing for drawing attention to the sub image. For example, the display mode of the main image may be set to a film mode, and the display mode of the sub image is set to a brighter mode than the film mode.

Fourth Modification

It is possible to configure the image generating module 51 so as to generate information in accordance with a turning-over shape as the sub image. For example, it is possible to configure the display processor 6 so as to display an image that meets a triangle as the sub image because when a corner of the main image is turned over, the turning-over shape is triangle.

Fifth Modification

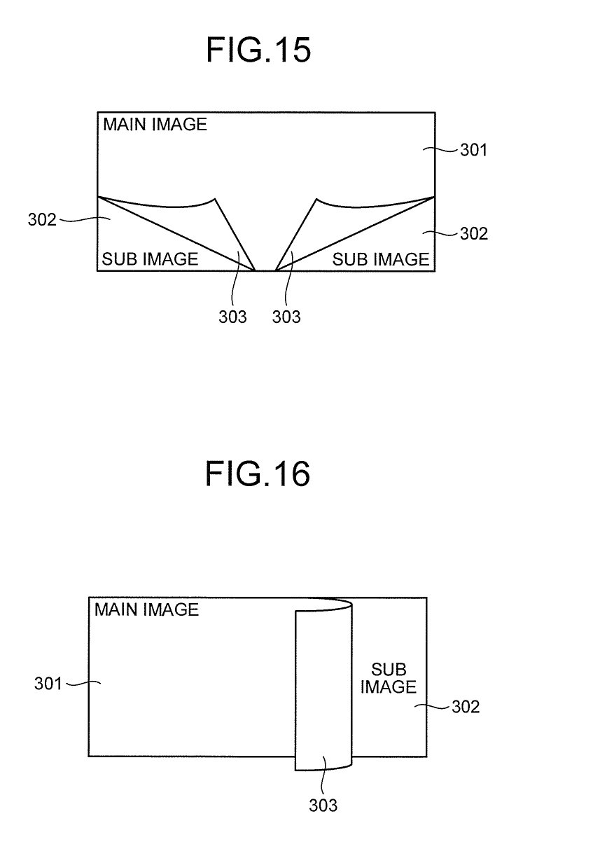

The above-described first to fourth embodiments and the modifications exemplify examples employing one piece of the turning-over image. However, embodiments are not limited thereto, and the image generating module 51 may be configured so as to generate a plurality of turning-over images to display a plurality of sub images. FIG. 15 illustrates an example in which the image generating module 51 generates two turning-over images and the main image 301 and the two sub images 302 are displayed.

Sixth Modification

The above-described first to fourth embodiments and the modifications are described with examples in which the turning-over image is generated by turning over a corner of the main image. However, a portion to be turned over is not limited to a corner as long as the portion is a part of the area of the main image. For example, it is possible to configure the image generating module 51 so as to generate a turning-over image by turning over an area including an edge of the main image. FIG. 16 illustrates an example in which an area of the right edge of the main image 301 is turned over by folding it and the sub image 302 is displayed on the area where the main image is turned over.

The video processor 5 or 605 and the audio processor 8 or 608 of the digital television set 1 in the first to fourth embodiments and the first to sixth modifications may be implemented as hardware or software.

When the video processor 5 or 605 and the audio processor 8 or 608 of the digital television set 1 in the first to fourth embodiments and the first to sixth modifications are implemented as software, a video processing program executed in the video processor 5 or 605 and an audio processing program executed in the audio processor 608 in the first to fourth embodiments and the first to sixth modifications are preliminarily stored in the ROM 13, etc. and then provided.

The video processing program executed in the video processor 5 or 605 and the audio processing program executed as the audio processor 608 in the first to fourth embodiments and the first to sixth modifications maybe recorded, as a file whose format is installable or executable, in a computer readable recording medium such as a compact disk read only memory (CD-ROM), a flexible disk (FD), a compact disk recordable (CD-R), and a digital versatile disk (DVD), and then provided.

The video processing program executed as the video processor 5 or 605 and the audio processing program executed as the audio processor 608 in the first to fourth embodiments and the first to sixth modifications may be stored in a computer connected to a network such as the Internet, and then provided by download thereof through the network. Alternatively, the video processing program executed as the video processor 5 or 605 and the audio processing program executed as the audio processor 608 in the first to fourth embodiment and the first to sixth modifications may be provided or distributed through a network such as the Internet.

The video processing program executed as the video processor 5 or 605 in the first to fourth embodiments and the first to sixth modifications is of a module configuration comprising the modules (image generating module 51, three-dimensional processor 52, image synthesizer 53, channel shifting controller 601) that are described above. As actual hardware, a central processing unit (CPU) reads out the video processing program from the ROM 13 and executes it, whereby the above-described modules are loaded on a main memory, and the image generating module 51, the three-dimensional processor 52, the image synthesizer 53, and the channel shifting controller 601 are generated on the main memory.

The audio processing program executed as the audio processor 8 or 608 in the first to fourth embodiments and the first to sixth modifications is of a module configuration comprising the module (volume controller 802) that is described above. As actual hardware, the CPU reads out the audio processing program from the ROM 13 and executes it, whereby the above-described module is loaded on the RAM 12, and the volume controller 802 are generated on the RAM 12.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
an image generating module configured to generate a turning-over image that is an image on a turning-over section obtained by folding a part of an area of a main image input, the main image being transmitted through the turning-over section; and
an image synthesizer configured to arrange a sub image on apart of the area of the main image, and synthesize the main image, the turning-over image, and the sub image.

2. The image processing apparatus of claim 1, further comprising an input receiving module configured to receive an input of a turning-over position of the main image, wherein
the image generating module is configured to generate the sub image differently depending on the turning-over position.

3. The image processing apparatus of claim 1, further comprising:
an input receiving module configured to receive an input of a turning-over amount of the main image;
a shifting controller configured to shift a channel to be controlled; and
a volume controller configured to control volume of audio corresponding to the main image and volume of audio corresponding to the sub image so that the volume of audio corresponding to the sub image is increased as the turning-over amount is increased, wherein
the shifting controller is configured to shift, when the turning-over amount is equal to or larger than a predetermined threshold, the channel to be controlled from a channel of the main image to a channel of the sub image.

4. The image processing apparatus of claim 1, further comprising:
an input receiving module configured to receive an input of a turning-over amount of the main image;
a shifting controller configured to switch a channel to be controlled; and
a volume controller configured to control volume of audio corresponding to the main image and volume of audio corresponding to the sub image, wherein
the shifting controller is configured to shift, when the turning-over amount is equal to or larger than a predetermined threshold, the channel to be controlled from a channel of the main image to a channel of the sub image, and
the volume controller is configured not to output audio of the channel of the sub image when the turning-over amount is smaller than the threshold, and configured to output the audio of the channel of the sub image when the turning-over amount is equal to or larger than the threshold.

5. The image processing apparatus of claim 1, wherein the image generating module is configured to determine whether contents related to the main image exist, and generate an image obtained by vibrating a part of the area of the main image if the contents related to the main image exist.

6. The image processing apparatus of claim 1, wherein the image generating module is configured to generate the turning-over image with a turning-over amount based on an amount of information to be displayed as the sub image.

7. The image processing apparatus of claim 1, wherein the image generating module is configured to perform image processing on the sub image for drawing attention of a user to the sub image.

8. The image processing apparatus of claim 1, further comprising a three-dimensional processor configured to convert the main image and the turning-over section of the main image to a stereoscopic image.

9. The image processing apparatus of claim 1, further comprising a display configured to display an image obtained by synthesizing the main image, the sub image, and the turning-over image.

10. An image processing method comprising:
generating an image to generate a turning-over image that is an image on a turning-over section obtained by folding a part of an area of a main image input, the main image being transmitted through the turning-over section;
arranging a sub image on a part of the area of the main image; and
synthesizing the main image, the turning-over image, and the sub image.
